(19) United States
(12) Patent Application Publication
(10) Pub. No.: US 2008/0229574 A1
(43) Pub. Date: Sep. 25, 2008

(54) Self chip redistribution apparatus and method for the same

(75) Inventors: Wen-Kun Yang, Hsin-Chu City (TW); Hsien-Wen Hsu, Lujhou City (TW); Chih-Wei Lin, Gueiren Township (TW); Ming-Chung Cheng, FongShan City (TW); Chih-Ming Chen, Sinpu Township (TW); Chun-Hiu Yu, Tainan City (TW)

Correspondence Address: ABELMAN, FRAYNE & SCHWAB, 666 THIRD AVENUE, 10TH FLOOR, NEW YORK, NY, 10017, US

(73) Assignee: ADVANCED CHIP ENGINEERING TECHNOLOGY INC.

(21) Appl. No.: 11/725,826

(22) Filed: Mar. 19, 2007

(51) Int. Cl. B23P 19/033

(52) U.S. Cl. 29/821

(57) ABSTRACT

The present invention provides an apparatus and a method for self chip redistribution. The apparatus of the present invention comprises a glass base on which a trench and a cavity formed by a layer of photo resistance. Chips are picked from a sawed wafer and placed on the glass base and moved by fluid flow to the front of index bar. The glass base and the index bar vibrate with low frequency to fill chips into chip cavities. The present invention further provides a method for self chip redistribution, comprising providing a self redistribution tool, transferring redistributed chips onto a panel forming tool, forming a chip panel and separating said chip panel from panel forming tool.

### FIELD OF THE INVENTION

The present invention relates to an apparatus and a method for chip redistribution, and more particularly to self chip redistribution.

### DESCRIPTION OF THE PRIOR ART

U.S. Pat. No. 3,439,416 discloses a method for manufacturing an array of magnetically coated discrete components. The components are placed on a matrix; wherein magnetized layers alternatively placed with non-magnetized layers on a matrix. Then the matrix is vibrated, by which the components move to desired positions for forming such an array. However, several limitations relating to the shape, size, and distribution of the components exist. In addition, self-alignment of components requires the presence of the laminated structure. Furthermore, the structures disclosed by this invention are incompatible with micron sized integrated circuit structures.

U.S. Pat. No. 4,542,397 discloses a method of self aligning and self locking parallelogram shaped elements on a substrate by mechanical vibration; however, elements have to be placed on a planar support surface in rough approximation of their desired array geometry before performing the compacting process.

U.S. Pat. No. 4,194,668 discloses an apparatus for aligning and soldering electrode pedestals to the solderable ohmic contacts of individual semiconductor components formed by an undivided silicon wafer. A silicon wafer is mounted on the soldering base plate, and then a mask with open through holes formed therein is mounted over the wafer and the open through holes aligned with the solderable anodic contacts of the wafer. Electrode pedestals are then sprinkled onto the mask and shaken onto the solderable anodic contacts via the mask holes. The mask of the invention is predefined and preferably made of bronze; moreover, the pedestals are feed with sloped feed surface, so that the apparatus requires a collection tray is equipped to recover the bounced pedestals.

U.S. Pat. No. 5,545,291 discloses a method for assembling blocks onto a substrate through fluid transport. The shaped blocks transfer into recessed regions located on a substrate via the shape and fluid; wherein, the transferring step is proceeded by spreading the shaped blocks into fluid and then poured the mixture evenly over the top surface of a substrate having recessed regions thereon. Then the blocks self-align, and engage into recessed regions.

To sum up, the invention disclosed by U.S. Pat. No. 3,439,416 only applies to elements with magnetic to obtain desired arrangement; the invention disclosed by U.S. Pat. No. 4,542,397 needs to place chips on a planar support surface in rough approximation of their desired array at the beginning of compacting step; the invention disclosed by U.S. Pat. No. 4,194,668 needs a mask able to withstand the impact when pedestal bouncing on the mask and a tray to recover the bounced pedestals; the invention disclosed by U.S. Pat. No. 5,545,291 fills the blocks into the recessed regions by pouring or spreading the mixture of fluid and blocks evenly over the top surface of a substrate; however, blocks already disposed in the recessed regions may float out, the invention may need to perform transferring step in centrifuge or to shape blocks and recession regions into trapezoidal profile for preventing blocks floating out of the recession regions.

Therefore, it is desirable to develop a method and an apparatus with characters of compactness, low cost, efficiency and reliability for distributing chips.

### SUMMARY OF THE INVENTION

One advantage of the present invention is providing a chip redistribution method and apparatus without demanding fine alignment.

One advantage of the present invention is providing a chip redistribution method and apparatus with high throughput (UPH 5 k˜10 k).

One advantage of the present invention is providing a chip redistribution method and apparatus with high accuracy for chip redistribution.

One advantage of the present invention is providing a chip redistribution method and apparatus with zero chip bonding force during process.

Another advantage of the present invention is providing a chip redistribution method and apparatus without generating silicon particle.

Another advantage of the present invention is providing a simple chip redistribution method and apparatus for forming a panel wafer.

Another advantage of the present invention is providing a chip redistribution method and apparatus without shaped block for chips and chip cavity.

Still another advantage of the present invention is providing a chip redistribution method and apparatus utilizing normal sawed chips and normal PR pattern.

The present invention provides a apparatus for self chip redistribution, comprising a plate for performing programmed low frequency vibration, a glass base mounted on said plate, a layer with a trench and a cavity formed on said glass base, a programmed nozzle installed in one end of said glass base for injecting fluid, stop bars placed on the upper surface of said layer for restricting said chips and an index bar installed on the top of said layer; wherein said index bar can move forwardly and backwardly and vibrate with low frequency for self chip redistribution.

The present invention further provides a method for self chip redistribution, comprising providing a base with a layer in which a chip cavity and a trench are formed, injecting a fluid, for example, water flow, on said base for moving said chip to the front of a index bar, filling said chip to said chip cavity by vibrating said base and said index bar with low vibrating frequency, transferring redistributed chips onto a panel forming tool, forming a chip panel and separating said chip panel from panel forming tool.

### BRIEF DESCRIPTION OF THE DRAWINGS

FIG. 1 illustrates top view of a pick and place system with a self chip redistribution tool; and

FIG. 2 illustrates front view of a self chip redistribution tool.

### DESCRIPTION OF THE PREFERRED EMBODIMENT

The invention will now be described in greater detail with preferred embodiments of the invention and illustrations attached. Nevertheless, it should be recognized that the preferred embodiments of the invention is only for illustrating. Besides the preferred embodiment mentioned here, present invention can be practiced in a wide range of other embodiments besides those explicitly described, and the scope of the present invention is expressly not limited except as specified in the accompanying claims.

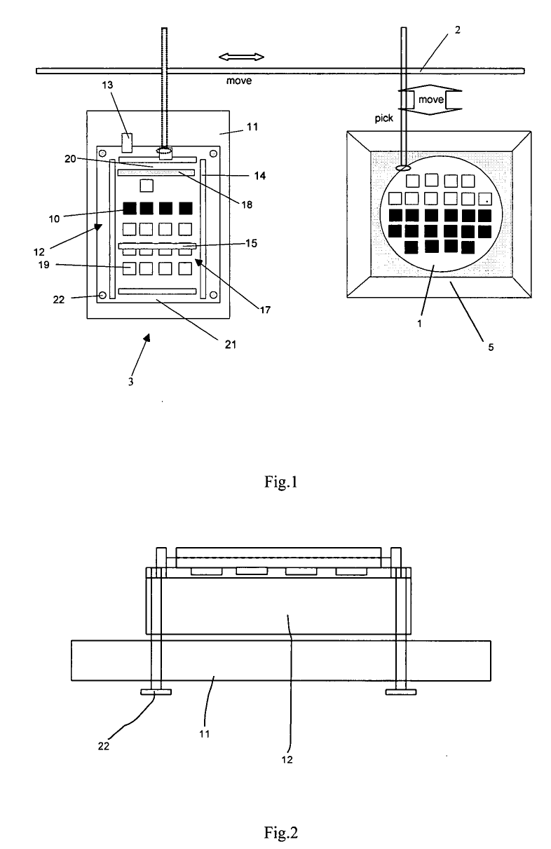

The present invention discloses an apparatus for self chip redistribution. As show in FIG. 1, the pick and place system comprises a sawed wafer 1 placing on a pick station 5, for example, a blue tape or a UV tape, a robot 2 for picking and placing a chip 10, and a self chip redistribution tool 3. A sawed wafer 1 is placed on a pick station 5 and a robot 2 is set and moves between the saw wafer 1 and self chip redistribution tool 3 for picking and plaacing a chip 10. The robot can select specific position and chip to perform picking and placing action (based on the mapping input).

Referring to FIG. 1, the self chip redistribution tool 3 mentioned above comprises a plate 11 for low frequency vibration, and a glass base 12; with thickness of 1.8 mm at least and several open through holes for fixing the glass plate 12 on the plate 11 is used for forming a chip arranging area 17; wherein the plate 11 can vibrate with low vibrating frequency. A photo resistance (PR), preferably, made of SU8, is coated on the glass base 12; wherein the thickness of PR is the same as (or slight higher than) that of the chip 10 the trench 18 for collecting silicon particles and the chip cavity 19 on the PR is formed by a photo mask with patterns; wherein the size of each side of the chip cavity 19 is 0 to 5 μm longer than the chip 10 for preventing the chip 10 disposed in the chip cavity 19 floating out and the width of the trench 18 is about 200 μm. In another embodiment of the present invention, the number of the trench 18 can be multiple. After the patterns are transferred to the PR, curing the PR in order to harden the surface of PR.

As shown in FIG. 2, The glass base 12 with patterned PR is mounted on the plate 11 and fixes by the connecting tool 22, for example, a screw or a plug. As shown in FIG. 1, four stop bar 16 for restricting the chip 10 are mounted on the PR for forming the chip arranging area 17; wherein the chip arranging area 17 is divided into chip placing area 20 and redistribution area 21 by trench 18.

A nozzle 13 is installed in front of the trench 18 on the glass base 12 for driving the chip 10 flowing to another end of the glass base 12. Several overflows are formed in stop bar 16 for keeping the water line between ⅓ and ½ of the thickness of a chip 10.

A index bar 15 is installed on the glass base 12 with a gap between the index bar 15 and the PR on the glass base 12; wherein the index bar 15 keeps parallel relationship to the upper surface of glass base 12 and the gap between index bar 15 and surface of fluid is zero; that is, the distance between the lower surface of the index bar 15 and the upper surface of the PR on the glass base equals to the waterline of fluid. The index bar 15 can move forwardly or backwardly and keep low frequency vibration at the same time for ensuring the chip 10 fill into the chip cavity 19. In another embodiment of the present invention, the self chip redistribution tool 3 further comprises a chip distance index bar.

The present invention further discloses a self chip redistribution method. In one embodiment of the present invention, the method of present invention provides a glass base, with thickness of 1.8 mm at least and several open through holes formed therein for fixing the glass base on a plate is used for forming a chip arranging area; wherein the plate can vibrate with low vibrating frequency. A photo resistance (PR), preferably, made of SU8, is coated on the glass base; wherein the thickness of PR is the same as (or slight higher than) that of the chip. Then, a photo mask with patterns is introduced for forming the trench for collecting silicon particles and the chip cavity; wherein the size of each side of the chip cavity is 0 to 5 μm longer than the chip for preventing the chip disposed in the chip cavity floating out and the width of the trench is about 200 μm. After the patterns are transferred to the PR, curing the PR in order to harden the surface of PR.

Next, the stop bar is mounted on the four end edge of the glass base for restricting the chip staying in the chip arranging area for chip redistribution. A water nozzle is placed in the front side of the glass base. After the steps described above is done, the glass base on the plate of Pick and Place system is fixed on the plate and then the index bar is placed in the place where the gap between index bar and water flow is zero; that is, the distance between the lower surface of the index bar and the upper surface of the PR on the glass base equals to the waterline. Then Fluid, for example, deionized (DI) water is injected to the chip arranging area from water nozzle; wherein the flow speed of DI water is adjusted to the required speed and the water line is about half of the thickness of the chip. In another embodiment of the present invention, the density of the fluid injected from the water nozzle is less than 1.

Next step is to pick the sawed wafer (frame form) on the pick area, for example, blue tape; then the desired chip is picked from sawed wafer and placed on the placement area of self chip redistribution tool; wherein chips are floating on the DI water and the chippings, that is, silicon particles, are removed and collected by the trench; wherein, in most case, the size of chipping [silicon particle] is less than 200 um; then chips moved by fluid flow to the redistribution area until intercepted by the front of the index bar. The plate and the index bar vibrate with low vibrating frequency; wherein the index bar vibrate in one-dimension, for example in left/right direction, to ensure the chips fall into the chip cavities. In one embodiment of the present invention, the vibrating frequency of the plate is between 1 Hz and 60 Hz and the vibrating frequency of the index bar is between 1 Hz and 60 Hz.

After the present row of the chip cavities is filled, the index bar moves to the next row of the chip cavities and repeats the process for filling the chip cavities with the chips. The process repeated until all the cavities on the redistribution area is filled and then water injection is shut. The index bar then returns to its starting line; if encountering a chip not falling into the chip cavity, the index bar would continue to vibrate with low frequency to fill the chip into the chip cavity. After the index bar return to its starting line, inspecting the chip cavities to make sure every cavities is filled with the chip.

Next step is to unlock the tool from the plate and then heat curing process is performed by oven. The panel forming tool with pattern glue is mounted on the chip redistribution tool; therefore, the pattern glue is stuck on the upper face of chips and then the chip redistribution tool is released from the panel. The core paste is printed on the back side of the chips for filling out the space between chip to chip. Then, a vacuum panel bonder is used for bonding the panel on the back side of the chips and heat curing process is executed for hardening the adhesive; therefore, the chips are bond together and forming a panel. Next the panel is separated from the panel forming tool under special condition, for example, proceeded with solvent or other chemicals. Next wet/dry process is introduced to clean the surface of the panel and chip surface; at last, then the panel is completed for next build up layers process.

In this application, several modification can be made to improve the accuracy, safety and through-put; for instant, dual index bar can be used to improve the through-put (one in die placement area), the guide bar is used on each column to improve the accuracy, and therefore chip will not flow to other column; the optical inspection is used to confirm the chip placement before moving the index bar to next row; the air blow function is added during the optical inspection to enhance the chip stage in cavity well, etc.

Although preferred embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. An apparatus for self chip redistribution, comprising:
a plate for performing low frequency vibration;
a glass base mounted on said plate;
a layer with a trench and a cavity formed on said glass base;
a nozzle installed in one end of said glass base for injecting fluid;
stop bars placed on the upper surface of said layer for restricting said chips; and
an index bar installed on the top of said layer; wherein said index bar can move forwardly and backwardly and vibrate with low frequency.

2. The apparatus of claim 2, further comprising
a pick area for placing a sawed wafer;
a robot for picking said chip from said sawed wafer and putting said chip to said apparatus for self chip redistribution, wherein said robot can select specific position to perform picking and placing action.

3. The apparatus of claim 1, wherein the thickness of said glass is 1.8 mm at least.

4. The apparatus of claim 1, wherein said layer is made of photo resistance.

5. The apparatus of claim 1, wherein the thickness of said layer is the same as or slight deeper than said chip.

6. The apparatus of claim 1, wherein the distance between said index bar and said layer equals waterline of said fluid.

7. The apparatus of claim 1, wherein each side of said chip cavity is 0 to 5 μm longer than said chip.

8. The apparatus of claim 1, wherein the width of said trench is about 200 μm.

9. The apparatus of claim 1, wherein said stop bar composes an overflow for keeping Water-line of said fluid at specific level.

10. The apparatus of claim 1, wherein the number of said trench is equal to or more than 1.

11. A method for self chip redistribution, comprising:
providing a base with a layer in which a chip cavity and a trench are formed;
injecting a fluid on said base for moving said chip to the front of a index bar;
filling said chip to said chip cavity by Vibrating said base and said index bar with low vibrating frequency;
transferring redistributed chips onto a panel forming tool;
forming a chip panel;
Separating said chip panel from panel forming tool.

12. The method of claim 11; further comprising wet/dry cleaning process for cleaning said chip panel surface.

13. The method of claim 11; wherein the step for forming said chip panel comprising printing a core paste on the backside of said chips for filling out the space between said chips;
using vacuum panel bonder for bonding said chip panel; and
performing heat curing process for hardening said core paste.

14. The method of claim 11; wherein said low vibrating frequency of said base is between 1 and 60 Hz.

15. The method of claim 11; wherein said low vibrating frequency of said index bar is between 1 and 60 Hz.

16. The method of claim 11; wherein waterline of said fluid is between ½ to ⅓ of the thickness of a chip.

17. A method of claim 11; wherein said fluid is deionic water or a fluid with density less than 1.

18. The method of claim 11; wherein said layer is photo resistance and said chip cavity and said trench is formed by transferring patterns on a photo mask to said photo resistance.

19. The method of claim 11; wherein said separating step is performed with a solvent.
